(19) United States
(12) Patent Application Publication
(10) Pub. No.: US 2006/0035067 A1
(43) Pub. Date: Feb. 16, 2006

(54) Film multilayer body and flexible circuity board

(76) Inventors: Hisashi Watanabe, Kisarazu-shi, Chiba-ken (JP); Seigo Shimizu, Kisarazu-shi, Chiba-ken (JP)

Correspondence Address: George A Loud;Bacon & Thomas, 625 Slaters Lane, Fourth Floor, Alexandria, VA, 22314-1176, US

(21) Appl. No.: 10/526,351

(22) PCT Filed: Sep. 10, 2003
(86) PCT No.: PCT/JP03/11588

§ 371 Date: Mar. 2, 2005

(30) Foreign Application Priority Data
Sep. 11, 2002 (JP) 2002-265862

(51) Int. Cl. B32B 3/00; B21D 39/00

(52) U.S. Cl. 428/209; 428/621; 174/254

(57) ABSTRACT

A film laminate permitting the formation of a fine pattern and being excellent in electrical reliability is provided. The film laminate is characterized in that a plasma CVD layer of an organic metal compound and an electrically conductive layer are successively formed on at least one side of a heat-resistant polymer film.

### TECHNICAL FIELD

The present invention relates to a film laminate and a flexible circuit board obtainable from the film laminate.

### BACKGROUND ART

In recent years, the density of pixels has become higher and higher in flat panel displays such as liquid crystal displays. It is, therefore, necessary that flexible circuit boards connected to the displays have high precision patterns. At the same time, it is important to ensure electrical reliability as the pitch of the patterns is narrowed.

Conventionally, copper clad laminates for flexible circuit boards have been produced by bonding a polyimide film to a surface-roughed copper foil using an adhesive such as an epoxy adhesive.

As problems of such a technique, lack in heat resistance and lack in electrical reliability have been pointed out.

To cope with these problems, a method is proposed in which a polyimide resin is directly applied on a copper foil by coating. Since the copper layer of the copper clad laminate is thick, however, it is difficult to ensure desired process precision of the fine pattern in the wiring board obtained by etching the copper of the laminate.

A method for preparing a copper clad laminate having a high adhesion strength without using an adhesive is also known in which, after a metal layer different from copper, such as nickel or chromium, has been formed as a primer layer on a polyimide film by sputtering or vapor deposition, electrolytic copper plating is performed. This method, however, causes a problem of delamination during implement because the adhesion strength is not fully satisfactory. Additionally, since the metal of the primer layer is apt to remain removed during the etching, the electrical reliability is not high. Further, a problem of a significant reduction of the adhesion strength is caused when a heat treatment is carried out for a long time.

It is an object of the present invention to provide a film laminate which permits the formation of fine patterns with ease and which has excellent electrical reliability and to provide a flexible circuit board obtainable from the laminate.

### DISCLOSURE OF THE INVENTION

In accordance with the present invention, there is provided a film laminate including a heat-resistant polymer film, a plasma CVD layer of an organic metal compound provided on at least one side of the heat-resistant polymer film, and an electrically conductive layer provided on the plasma CVD layer.

The present invention also provides a flexible circuit board including the above film laminate in which the electrically conductive layer is patterned to form a circuit, and a copper plating layer provided on the circuit.

The present invention further provides a flexible circuit board obtainable by a method including forming a photosensitive resin over the electrically conductive layer of the above film laminate, patterning the photosensitive layer to expose the electrically conductive layer, copper-plating the exposed electrically conductive layer to form a copper layer, and removing remaining photosensitive resin and the electrically conductive layer below the remaining photosensitive resin.

### BEST MODE FOR CARRYING OUT THE INVENTION

The heat-resistant polymer film used in the present invention has a melting temperature (melting point) of at least 250° C., preferably at least 300° C. Examples of the polymer film include polyimide films, aromatic polyamide films, liquid crystal polyester films, polyether sulfone films, polyether-ether ketone films, polyparabanic acid films, polyvinyl fluoride films and polyether imide films.

For reasons of heat resistance, polyimide films, aromatic polyamide films and liquid crystal polyester films are preferred. More preferred are polyimide films.

A polyimide resin is a conventionally well known resin and is generally obtainable by polycondensation of an aromatic tetracarboxylic dianhydride with an aromatic diamine used as main components.

Examples of the aromatic tetracarboxylic dianhydride which constitutes the polyimide resin include pyromellitic dianhydride, 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, naphthalene-2,3,6,7-tetracarboxylic dianhydride, naphthalene 1 2 5 6-tetracarboxylic dianhydride, naphthalene-1,2,4,5-tetracarboxylic dianhydride, naphthalene-1,4,5,8-tetracarboxylic dianhydride, naphthalene-1,2,6,7-tetracarboxylic dianhydride, 4,8-dimethyl-1,2,3,5,6,7-hexahydronaphthalene-1,2,5,6-tetracarboxylic dianhydride, 4,8-dimethyl-1,2,3,5,6,7-hexahydronaphthalene-2,3,6,7-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride and 1,4,5,8-tetrachloronaphthalene-2,3,6,7-tetracarboxylic dianhydride, although not limited to these examples.

Additionally, 3,3′,4,4′-diphenyltetracarboxylic dianhydride, 2,2′,3,3′-diphenyltetracarboxylic dianhydride, 2,3,3′,4′-diphenyltetracarboxylic dianhydride, 3,3″,4,4″-paraterphenyltetracarboxylic dianhydride, 2,2″,3,3″-paraterphenyltetracarboxylic dianhydride, 2,3,3″,4″-paraterphenyltetracarboxylic dianhydride, 2,2-bis(2,3-dicarboxyphenyl)propane dianhydride, 2,2-bis(3,4-dicarboxyphenyl)propane dianhydride, bis(2,3-dicarboxyphenyl)ether dianhydride, bis(3,4-dicarboxyphenyl)ether dianhydride, bis(2,3-dicarboxyphenyl)methane dianhydride, bis(3,4-dicarboxyphenyl)methane dianhydride, bis(2,3-dicarboxyphenyl)sulfone dianhydride, bis(3,4-dicarboxyphenyl)sulfone dianhydride, 1,1-bis(2,3-dicarboxyphenyl)ethane dianhydride, 1,1-bis(3,4-dicarboxyphenyl)ethane dianhydride, perylene-2,3,8,9-tetracarboxylic dianhydride, perylene-3,4,9,10-tetracarboxylic dianhydride and perylene-4,5,10,11-tetracarboxylic dianhydride may be mentioned.

Moreover, there may be mentioned perylene-5,6,11,12-tetracarboxylic dianhydride, phenanthrene-1,2,7,8-tetracarboxylic dianhydride, phenanthrene-1,2,6,7-tetracarboxylic dianhydride, phenanthrene-1,2,9,10-tetracarboxylic dianhydride, cyclopentane-1,2,3,4-tetracarboxylic dianhydride, pyrazine-2,3,5,6-tetracarboxylic dianhydride, pyrrolidine-2,3,4,5-tetracarboxylic dianhydride, thiophene-2,3,4,5-tetracarboxylic dianhydride and, 4,4′-oxydiphthalic dianhydride. The aromatic tetracarboxylic dianhydride is not limited to these examples. These compounds may be used singly or as a mixture of two or more thereof.

Examples of the diamine component include 3,3′-dimethyl-4,4′-diaminobiphenyl, 4,6-dimethyl-m-phenylenediamine, 2,5-dimethyl-p-phenylenediamine, 2,4-diaminomesitylene, 4′4-methylene di-o-toluidine, 4,4′-methylene 2,6-xylidine, 4,4′-methylene 2,6-diethylaniline, 2,4-toluenediamine, m-phenylenediamine, p-phenylenediamine, 4,4′-diaminodiphenylpropane, 3,3′-diamino-diphenylpropane, 4,4′-diaminodiphenylethane, 3,3,-diaminodiphenylethane, 4,4′-diaminodiphenylmethane, 3,3′-diaminodiphenylmethane and 2,2-bis[4-(4-aminophenoxy)phenyl]propane, although not limited to these examples.

Additionally, 4,4′-diaminodiphenylsulfide, 3,3′-diaminodiphenylsulfide, 4,4′-diaminodiphenylsulfone, 3,3′-diaminodiphenylsulfone, 4,4′-diaminodiphenyl ether, 3,3-diaminodiphenyl ether, benzidine, 3,3′-diaminobiphenyl, 3,3′-dimethyl-4,4′-diaminobiphenyl, 3,3′-dimethoxybenzidine, 4,4′-diamino-p-terphenyl, 3,3′-diamino-p-terphenyl, bis(p-aminocyclohexyl)methane, bis(p-β-amino-t-buthylphenyl)ether, bis(p-β-methyl-δ-aminopentyl)benzene, p-bis(2-methyl-4-aminopentyl)benzene, p-bis(1,1-dimethyl-5-aminopentyl)benzene, 1,5-diaminonaphthalene, 2,6-diaminonaphthalene, 2,4-bis(β-amino-t-butyl)toluene, 2,4-diaminotoluene, m-xylene-2,5-diamine, p-xylene-2,5-diamine, m-xylylenediamine, p-xylylenediamine, may be mentioned.

Moreover, there may be mentioned 2,6-diaminopyridine, 2,5-diaminopyridine, 2,5-diamino-1,3,4-oxadiazole, piperazine, 1,3-bis(3-aminophenoxy)benzene, 2,5-diaminophenol, 3,5-diaminophenol, 4,4′-(3,3′-dihydroxy)diaminobiphenyl, 4,4′-(2,2′-dihydroxy)diaminobiphenyl, 2,2′-bis(3-amino-4-dihydroxyphenyl)hexafluoropropane, 2,5-diaminobenzoic acid, 3,5-diaminobenzoic acid, 4,4′-(3,3′-dicarboxy)diaminobiphenyl, 3,3′-dicarboxy-4,4′-diaminodiphenyl ether, ω,ω′-bis(2-aminoethyl)poly dimethylsiloxane, ω,ω′-bis(3-aminopropyl)polydimethylsiloxane, ω,ω′-bis(4-aminophenyl) polydimethylsiloxane, ω,ω′-bis(3-aminopropyl)polydiphenylsiloxane and ω,ω′-bis(3-aminopropyl)polymethylphenylsiloxane. The diamine component is not limited to these examples. These compounds may be used singly or as a mixture of two or more thereof.

The reaction of the acid anhydride compound with the diamine compound in a polar solvent gives a polyamic acid solution which is a precursor of a polyimide.

A polyimide film may be generally obtained by casting the polyamic acid solution on a substrate. The cast solution is dried and then subjected to imidization at a high temperature. Alternately, the solution is heated to effect the imidization. The resulting solution is cast on a substrate, dried and heat-treated to give the film.

The heat-resistant polymer film used in the present invention may be constructed into a multi-layered structure or may be compounded with various kinds of additives, if desired.

Further, a surface of the polymer film may be previously mechanically roughened or chemically activated for enhancing the adhesion strength.

Furthermore, for the purpose of improving the adhesion between the polymer film and the plasma CVD layer of an organic metal compound, a layer of various resins which has a thickness of 0.1 to 5 μm, preferably 0.5 to 3 μm, and which has high adhesiveness may be provided on that surface of the polymer film which is to be overlaid with the plasma CVD layer. Particularly preferable is to provide a fluorinated polyimide resin layer or a silicone-polyimide resin layer having a thickness of 5 μm or less.

The fluorinated polyimide resin may be obtained by using, as at least part of the above-described acid anhydride compound for the production of polyimide resin, a fluorine group-containing acid anhydride such as 2,2-bis(3-phthalic anhydride)hexafluoropropane or 2,2-bis{phenylether(3-phthalic anhydride)}hexafluoropropane and/or by using, as at least part of the above-described amine compound, a fluorine group-containing diamine compound such as 2,2-bis{4-(4-aminophenoxy)phenyl}-hexafluoropropane, 2,2-bis(4-aminophenyl)hexafluoropropane, 2,2-bis(3-amino-4-methylphenyl)hexafluoropropane, 2,2′-(trifluoromethyl)benzidine or 2,2-bis(3-amino-4-hydroxyphenyl)hexafluoropropane.

It is preferred that the silicone-polyimide resin contain at least 10 mole % of the above-mentioned silicone-diamine compound based on a total diamine compounds for reasons of adhesion strength. The suitable content of the silicone-diamine compound is 20 to 80 mole %.

While the heat-resistant polymer film may have any thickness, the thickness thereof is preferably 10 to 150 μm for the standpoint of the fabrication of flexible printed wiring boards. A thickness below 10 μm will result in low stiffness and in poor machinability. Too large a thickness in excess of 150 μm will cause a difficulty in machining such as bending.

The plasma CVD layer of an organic metal compound is formed on at least one side of the thus fabricated heat-resistant polymer film by any suitable known method such as glow discharge in the vapors of the organic metal compound.

Preferably, a discharge voltage of at least 1,000 V is applied between electrodes in an inside electrode-type low temperature plasma generating apparatus to cause glow discharge. A surface of the heat-resistant polymer film is treated in the low temperature plasma atmosphere.

The low temperature plasma treatment is carried out in the presence of an inorganic gas such as helium, neon, argon, nitrogen, oxygen, air, nitrous oxide, nitrogen monoxide, nitrogen dioxide, carbon monoxide, carbon dioxide, ammonia, steam, hydrogen, sulfur dioxide or hydrogen cyanide. These inorganic gases may be used singly or as a mixture of two or more thereof.

The gas atmosphere within the apparatus preferably has a total pressure of 0.001-10 Torrs, more preferably 0.1 to 1.0 Torr. A total pressure of lower than 0.001 or higher 10 Torrs is not preferable because the discharge is not stable.

Under such a gas pressure, an electric power of 10 W to 100 KW by high frequency of 10 KHz to 2 GHz is applied between the discharge electrodes to cause stable glow discharge. The discharge frequency band is not limited to the high frequency. Low frequency, microwave or direct current may be also usable.

The low temperature plasma generating apparatus is desirably of an internal electrode-type. However, an external electrode-type apparatus is used, if necessary. Capacitive coupling such as a coil furnace or inductive coupling may be adopted.

The shape of the electrodes is not specifically limited. Thus, the electrodes may be in various forms such as flat plate-like, ring-like, rod-like or cylinder-like forms. Further, an electrically grounded inside metal wall of the treatment apparatus may be used as one of the electrodes.

In order to maintain stable low temperature plasma by applying a voltage of 1,000 V or more between the electrodes, it is necessary to use an input electrode provided with an insulation coating having a high withstand voltage. When a naked metal electrode such as copper, iron or aluminum is used, arc discharge is apt to be caused. Thus, the surface of the electrode is desirably provided with a coat such as an enamel coat, a glass coat or a ceramic coat.

The organic metal compound used in the present invention is not specifically limited as long as it permits plasma CVD and has a boiling point of 50 to 400° C., preferably 100 to 300° C.

As the organic metal compound, any compound containing a metal such as Si, Ti, Al, B, Mo, Ni or Zn may be arbitrarily selected. The preferred organic metal compound is at least one member selected from organic silicon compounds, organic titanium compounds and organic aluminum compounds.

The organic silicon compound is a compound having a Si atom to which at least one hydrocarbyl group or hydrocarbyloxy group is bonded. Such an organic silicon compound may involve an organic monosilane compound represented by the following general formula (1): 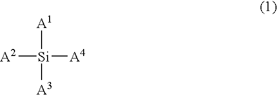
wherein A¹ through A⁴ each represent a hydrocarbyl group or a hydrocarbyloxy group with the proviso that at least one of A¹ through A⁴, preferably one to three of A¹ through A⁴, is a hydrocarbyloxy group.

The hydrocarbyl group may be an aliphatic hydrocarbyl group having 1 to 18 carbon atom or an aromatic hydrocarbyl group having 6 to 18 carbon atoms. The aliphatic hydrocarbyl group may be a liner aliphatic hydrocarbyl group having 1 to 18 carbon atoms or a cyclic aliphatic hydrocarbyl group having 4 to 18 carbon atoms. The linear aliphatic hydrocarbyl group may be an alkyl group having 1 to 18, preferably 1 to 10, more preferably 1 to 4 carbon atoms or an alkenyl group having 2 to 18, preferably 2 to 10, more preferably 2 to 4 carbon atoms. The cyclic aliphatic hydrocarbyl group may be a cycloalkyl group or a cycloalkenyl group each having 4 to 18, preferably 5 to 10, more preferably 6 to 8 carbon atoms.

The aromatic hydrocarbyl group may be an aryl group having 6 to 18, preferably 6 to 14, more preferably 6 to 10 carbon atoms or an arylalkyl group having 7 to 18, preferably 7 to 14, more preferably 7 to 10 carbon atoms.

Specific examples of the hydrocarbyl group include methyl, ethyl, propyl, hexyl, decyl, vinyl, 3-butenyl, cyclohexyl, cyclooctyl, cyclododecyl, cyclohexenyl, cyclooctynyl, phenyl, tolyl, xylyl, phenethyl, benzylphenyl, benzyl, phenethyl, phenylbenzyl, and naphthylmethyl.

The hydrocarbyl group may have a substituent which is inert to the reaction and which is able to be bonded to a carbon atom. Examples of the substituent include a halogen atom, a hydroxyl group, a cyano group, an amino group, a substituted amino group (e.g. methylamino, dimethylamino), an alkoxy group (e.g. methoxy, ethoxy) and an alkoxycarbonyl group (e.g. methoxycarbonyl).

The hydrocarbyl group of the hydrocarbyloxy group may be an aliphatic hydrocarbyl group having 1 to 10 carbon atoms or an aromatic hydrocarbyl group having 6 to 12 carbon atoms. The aliphatic hydrocarbyl group may be an alkyl group having 1 to 10, preferably 1 to 6, more preferably 1 to 4 carbon atoms or an alkenyl group having 2 to 10, preferably 2 to 6, more preferably 2 to 4 carbon atoms. The cyclic hydrocarbyl group may be a cycloalkyl group or a cycloalkenyl group each having a having 4 to 12, preferably 5 to 10, more preferably 6 to 8 carbon atoms. The aromatic hydrocarbyl group may be an aryl group having 6 to 12, preferably 6 to 10, more preferably 6 to 8 carbon atoms or an arylalkyl group having 7 to 12, preferably 7 to 10, more preferably 7 to 8 carbon atoms. These hydrocarbyl groups may have a substituent.

Examples of the hydrocarbyloxy group include alkoxy groups (e.g. methoxy, ethoxy and butoxy), aryloxy groups (e.g. phenoxy and naphthoxy) and arylalkyloxy groups (e.g. benzyloxy, phenethyloxy and naphthylmethoxy).

In the above-described organic monosilane compound, the average carbon number per one Si atom contained therein is 4 to 30, preferably 4 to 10. Specific examples of the organic monosilane compound include tetraethoxysilane, tetramethoxysilane, methyltrimetoxysilane, methyltriethoxysilane, methyldiethoxysilane, diethyldiethoxysilane, dimethyldiethoxysilane, dimethyldimethoxysilane, dimethylethoxysilane, ethyltriethoxysilane, ethyltrimethoxysilane, triethylethoxysilane, trimethylethoxysilane, dimethyldipropoxysilane, n-butyltrimethoxysilane, acetoxypropyltrimethoxysilane, acetoxytrimethylsilane, 2-(acryloxyethoxy)trimethylsilane, (3-acryloxyprophyl)dimethylmethoxysilane, (3-acryloxyprophyl)methyldimethoxysilane, (3-acryloxyprophyl)trimethoxysilane, 3-(N-allylamino)-propyltrimethoxysilane, allylaminotrimethylsilane, allyldimethoxysilane, allyltriethoxysilane, allyltrimethoxysilane, 4-aminobutyltriethoxysilane, N-(2-aminoethyl)-3-aminopropylmethyldimethoxysilane, N-(2-aminoethyl)-3-aminopropyltrimethoxysilane, 3-aminopropylmethyldiethoxysilane, 3-aminopropyltriethoxysilane, (3-glycidoxypropyl)-dimethylethoxysilane, (3-glycidoxypropyl)-methyldiethoxysilane, (3-glycidoxypropyl)-methyldimethoxysilane, (3-glycidoxypropyl)trimethoxysilane, 3-mercaptopropyltriethoxysilane, 3-mercaptopropyl-trimethoxysilane, methacryloxypropyltrimethoxysilane, methacryloxypropyltris(methoxyethoxy)silane, N-phenylaminopropyltrimethoxysilane, phenyltriethoxysilane, vinylmethyldiethoxysilane, vinyltriethoxysilane, vinyltrimethoxysilane.

In addition to the above-described organic monosilane compound, the organic silicone compound used in the present invention may be an organic polysilane compound or an organic polysiloxane compound.

The organic polysilane compound is one which contains generally 2 to 20 Si atoms in one molecule thereof and in which each of the Si atoms has at least one hydrocarbyl or hydrocarbyloxy group bonded thereto. As the hydrocarbyl group of the polysilane compound, there may be mentioned various hydrocarbyl groups indicated above with reference to the organic monosilane compound.

In the above-described organic polysilane compound, the average carbon number per one Si atom contained therein is 2 to 30, preferably 2 to 10.

Specific examples of the organic polysilane compound include hexamethyldisilane, hexaethyldisilane, 1,2-diphenyltetramethyldisilane and hexamethoxydisilane, hexaphenyldisilane.

The organic siloxane compound is a compound which has a SiOSi linkage in the molecular chain thereof. In the case of the present invention, the number of the SiOSi linkage is 1 to 20, preferably 1 to 10. Each Si atom has 1 to 2 hydrocarbyls or hydrocarbyloxys bonded thereto. As the hydrocarbyl and hydrocarbyloxy groups of the siloxane compound, there may be mentioned various hydrocarbyl and hydroxarbyloxy groups indicated above with reference to the organic monosilane compound. The organic polysiloxane compound may be one which has a recurring unit represented by the following general formula (2): 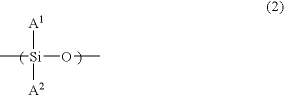
wherein A¹ and A² each represent a hydrocarbyl group or a hydrocarbyloxy group which may have a substituent. As the hydrocarbyl and hydrocarbyloxy groups of the polysiloxane compound, there may be mentioned various hydrocarbyl and hydroxarbyloxy groups indicated above with reference to the organic monosilane compound.

Specific examples of the organic siloxane compound include hexamethylsiloxane, vinyltetramethylsiloxane, polydimethylsiloxane having a number average molecular weight 1 to 1000.

The organic titanium compound used in the present invention is a compound having a Ti atom to which at least one hydrocarbyl group, a hydrocarbyloxy group or a hydrocarbyl group-substituted amino group is bonded. Such an organic titanium compound may be a compound represented by the following general formula (3): 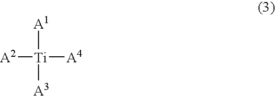
wherein at least one of A¹ through A⁴ represents a hydrocarbyl group, a hydrocarbyloxy group or a hydrocarbyl group-substituted amino group. As the hydrocarbyl and hydrocarbyloxy groups of the organic titanium compound, there may be mentioned various hydrocarbyl and hydroxarbyloxy groups indicated above with reference to the organic monosilane compound.

Specific examples of the organic titanium compound include titanium tetraethoxide, titanium tetramethoxide, titanium tetraisopropoxide, tetrakis (dimethylamino)titanium and tetrakis(diethylamino) titanium.

The organic aluminum compound used in the present invention is a compound having a Al atom to which at least one hydrocarbyl group or a hydrocarbyloxy group is bonded. Such an organic aluminum compound may be a compound represented by the following general formula (4): 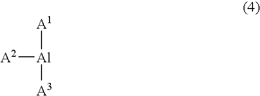
wherein at least one of A¹ through A³ represents a hydrocarbyl group or a hydrocarbyloxy group. As the hydrocarbyl and hydrocarbyloxy groups of the organic aluminum compound, there may be mentioned various hydrocarbyl and hydroxarbyloxy groups indicated above with reference to the organic monosilane compound.

Specific examples of the organic aluminum compound include aluminum tri(isopropoxide), tri(ethoxy)aluminum, aluminum butoxide and aluminium phenoxide.

Further, the organic aluminum compound used in the present invention may be an organic complex compound of aluminum such as aluminium acetylacetonato, aluminum ethylacetoacetate, aluminum methacrylate, aluminum pentanedionate.

By subjecting one or both sides of the heat-resistant polymer film to plasma CVD using the above-described organic metal compound, a plasma CVD layer may be formed on one or both sides of the heat-resistant polymer film. The CVD layer has a chemical structure containing part of organic residues in addition to the metal. Such a CVD layer thus produced may be subjected to a heat treatment or to a plasma treatment again in an inorganic gas atmosphere so as to remove unnecessary organic residues. The plasma CVD layer has a thickness of 0.01 to 1 μm, preferably 0.02 to 0.1 μm.

The plasma CVD layer serves to improve the adhesiveness and to function as a barrier to oxygen and moisture.

An electrically conductive layer is provided on the thus obtained plasma CVD layer. As the conductor, any conductive metal may be used. From the standpoint of etching property, copper is suitably used. As long as the etching property is not adversely affected, a different metal such as Ni or Cr may be provided in the interface for various desired purposes.

An electroless plating method, a vacuum deposition method, a sputtering method, etc. may be adopted for the formation of the electrically conductive layer. For reasons of adhesion strength, a sputtering method is suitably used.

The thickness of the electrically condutive layer may be arbitrarily determined depending upon the need for the desired circuit. From the standpoint of economy, a thickness of 1 μm or less is preferred in the case of a sputtered layer.

When a design of the circuit requires a large copper thickness, the conductive layer can be thickened by electrolytic plating using the sputtered layer as an electrode. In such a case, the thickness of the conductive layer is preferably 20 μm or less from the standpoint of stress during the plating. In general, the thickness of the electrically conductive layer is 1 to 20 μm, preferably 3 to 12 μm.

A surface layer containing any organic or inorganic rust prevention agent may be provided on a surface of the electrically conductive layer for the prevention thereof from oxidation.

A flexible circuit board may be obtained by subjecting the electrically conducitive layer, formed by overlaying a plating layer on the sputtered layer, in any customarily employed method including masking, patterning and etching.

For the formation of more precise flexible circuit board, a semi-additive method may be employed. In this method, a photosensitive resin layer is provided over the sputtered layer. The resin layer is then patterned to expose the sputtered layer. Using the exposed sputtered layer as an electrode, an electrolytic plating is carried out to form a thick copper layer thereon. Thereafter, the remaining photosensitive resin layer and the sputtered layer beneath the photosensitive layer are removed to obtain a flexible circuit board.

### EXAMPLE

The present invention will be next concretely described by examples which are not, however, restrictive of the present invention.

In the examples and comparative examples, the adhesion strength was measured as follows. Copper plating was performed to obtain a copper layer having a thickness of 10 μm. This was subjected to etching to obtain a linear wiring having a width of 2 mm. The film-side surface of the board was lined with an aluminum plate with a thickness of 1 mm using a double coated adhesive tape. The wiring was drawn at a rate of 5 cm/minute in a direction of 180 degrees to measure the peel strength.

The coefficient of thermal expansion, water absorption coefficient, and solder-proof property are measured as follows.

A thermomechanical analyzer (manufactured by Seiko Instruments Co., Ltd.) was used for the measurement of the coefficient of thermal expansion. A sample was heated to 255° C. and maintained at that temperature for 10 minutes. Then, the heated sample was cooled at a rate of 5° C./minute. An average coefficient of thermal expansion (coefficient of thermal expansion) from 240° C. to 100° C. was determined.

A sample film was immersed in water at 25° C. for 24 hours for the measurement of the water absorption efficiency. The film was then taken out from the water and the weight thereof was measured after the surfaces thereof had been lightly wiped. The water absorption coefficient was determined from the change in weight of the film before and after the immersion.

To measure the solder-proof property, a sample laminate was allowed to absorb water until the above-described saturated point. The sample was then immersed in solder baths having temperatures varying at an interval of 10° C. The solder-proof property is the highest temperature of the solder below which no bulge occurred.

The abbreviations used in the examples are as follows:

DAPE: 4,4′-diaminodiphenyl ether

BAPB: 4,4′-bis(3-aminophenoxy)biphenyl

BAPP: 2,2′-bis[4-(4-aminophenoxy)phenyl]propane

PMDA: pyromellitic dianhydride

BPDA: 3,3′,4,4′-biphenyltetracarboxylic dianhydride

6FDA: 4,4′-(hexafluoroisopropylidene)diphthalic anhydride

DMAc: N,N-dimethylacetamide

### Synthesis Example 1

425 Grams of DMAC was provided in a one-liter separable flask, into which 0.05 mol of DAPE and 0.05 mol of BAPP were dissolved with stirring. Next, 0.1 mol of 6FDA was added thereto under the nitrogen air flow. Then, the polymerization reaction was performed with continuous stirring to obtain a viscous solution of polyimide precursor A.

### Synthesis Example 2

425 Grams of DMAc was provided in a one-liter separable flask, into which 0.1 mol of BAPB was dissolved with stirring. Next, 0.1 mol of BPDA was added thereto under the nitrogen air flow. Then, the polymerization reaction was performed with continuous stirring to obtain a viscous solution of polyimide precursor B.

### Example 1

KAPTON EN Film (38 μm in thickness) manufactured by Toray Industries, Inc. was secured to a drive drum of a vacuum device. Then the device was made vacuum to 0.001 Torr. Next, tetramethoxysilane vapors were introduced into the vacuum system, and the pressure was controlled at 0.20 Torr. A high-frequency voltage of 13.5 MHz was applied to a surface of the film so that one side of the film was subjected to a plasma treatment at a discharge power density of 300 W·min/m². Thereby, a plasma CVD layer composed mainly of SiO was formed.

Further, using a sputtering device, the plasma-treated surface of the film was subjected to sputtering to deposit copper to a thickness of 3000 angstroms. Using the copper layer as an electrode, an electrolyte plating was carried out to form a copper layer with a thickness of 10 μm.

The measurement of the copper layer revealed that the adhesion strength thereof was 0.6 kg/cm. The laminate film was heat treated at 150° C. in a recirculating-type oven for 10 days. Then, the laminate was measured for the adhesion strength in the same manner as above. The adhesive strength was found to be unchanged and 0.6 kg/cm. The water absorption efficiency of the KAPTON EN Film was found to be 2.0%. The coefficient of thermal expansion was found to be 2×10⁻⁵/° C. The solder-proof property of the film laminate was found to be 280° C.

### Example 2

In Example 1, prior to the plasma treatment, a vanish of the polyimide precursor A was applied to the film such that the thickness of the coating after drying and curing was 1 μm. The vanish thus applied was then heated to 270° C. to perform a heat treatment.

The resulting film was then subjected to a plasma treatment and copper sputtering treatment in the same manner as that in Example 1. The copper layer was measured for the adhesion strength. The initial adhesion strength was found to be 1.0 kg/cm and to be unchanged after a heat treatment at 150° C. The solder-proof property was found to be 280° C.

### Example 3

In Example 1, prior to the plasma treatment, a vanish of the polyimide precursor B was applied to the film such that the thickness of the coating after drying and curing was 1 μm. The vanish thus applied was then heated to 270° C. to perform a heat treatment.

The resulting film was then subjected to a plasma treatment and copper sputtering treatment in the same manner as that in Example 1. The measurement of the adhesion strength revealed that the initial adhesion strength was 0.8 kg/cm and was unchanged after a heat treatment at 150° C. The solder-proof property was found to be 280° C.

### Example 4

In Example 2, the tetramethoxysilane was substituted by polydimethylsiloxane SH-200 (manufactured by Toray Dow Silicone Inc.) having a number average molecular weight of 1˜2. The test was performed in the same manner.

The thus obtained laminate had an initial adhesion strength of 0.9 kg/cm. After 10 days at 150° C., the adhesion strength was 0.9 kg/cm. The solder-proof property was 290° C.

### Example 5

In Example 2, the tetramethoxysilane was substituted by titanium tetramethoxide. The test was performed in the same manner.

The thus obtained laminate had an initial adhesion strength of 0.9 kg/cm. After 10 days at 150° C., the adhesion strength was 0.8 kg/cm. The solder-proof property was 290° C.

### Example 6

The test was performed such that, in Example 1, the KAPTON EN was substituted by APICAL HP Film (manufactured by Kanegafuchi Kagaku) having a thickness of 38 μm.

The thus obtained laminate had an initial adhesion strength of 0.9 kg/cm. After 10 days at 150° C., the adhesion strength was 0.9 kg/cm. The solder-proof property was 320° C. The water absorption coefficient of APICAL HP Film was 1.5%. The coefficient of thermal expansion was found to be 1×10⁻⁵/° C.

### Example 7

The test was performed such that, in Example 2, the KAPTON EN was substituted by a liquid crystal polyester film (manufactured by Japan Gore Inc.) having a thickness of 50 μm.

The thus obtained laminate had an initial adhesion strength of 0.7 kg/cm. After 10 days at 150° C., the adhesion strength was 0.7 kg/cm. The solder-proof property was 400° C. The water absorption coefficient of the liquid crystal polyester film was 0.3%. The coefficient of thermal expansion was found to be 5×10⁻⁶/° C.

### Example 8

In Example 2, a photosensitive dry film (thickness: 25 μm) was laminated on the laminate which had been subjected to the sputtering. The photosensitive dry film was then exposed and developed for patterning. The exposed sputtered layer was subjected to electrolytic copper plating in the same manner as that in Example 2. After the resist layer had been removed, the sputtered Cu layer was slightly etched using a ferric chloride solution.

The thus obtained wiring had the same properties as those of Example 2.

### Comparative Example 1

A laminate was prepared in the same manner as that in Example 1 except that no plasma treatment was carried out.

The thus obtained laminate had an initial adhesion strength of 0.3 kg/cm. After 10 days at 150° C., the adhesion strength was 0.1 kg/cm. The solder-proof property was 230° C.

### Comparative Example 2

A laminate was prepared in the same manner as that in Example 2 except that no plasma treatment was carried out.

The thus obtained laminate had an initial adhesion strength of 0.6 kg/cm. After 10 days at 150° C., the adhesion strength was 0.1 kg/cm. The solder-proof property was 240° C.

1. A film laminate comprising a heat-resistant polymer film, a plasma CVD layer of an organic metal compound provided on at least one side of said heat-resistant polymer film, and an electrically conductive layer provided on said plasma CVD layer.

2. The film laminate as recited in claim 1, wherein said organic metal compound includes at least one member selected from the group consisting of organic silicon compounds, organic titanium compounds and organic aluminum compounds.

3. The film laminate as recited in claim 1, wherein said heat-resistant polymer film is at least one member selected from the group consisting of aromatic polyimide films, liquid crystal polyester films and aromatic polyamide films.

4. The film laminate as recited in claim 1, wherein said heat-resistant polymer film is an aromatic polyimide film having a water absorption coefficient of 2% or less and a linear expansion coefficient of 2×10⁻⁵/° C. or less.

5. The film laminate as recited in claim 1, additionally comprising a resin layer which has a thickness of 5 μm or less, which is provided between said heat-resistant polymer layer and said plasma CVD layer and which contains a fluorinated polyimide resin or a silicone-polyimide resin.

6. The film laminate as recited in claim 1, wherein said electrically conductive layer is a copper layer formed by a sputtering method and having a thickness of 1 μm or less.

7. The film laminate as recited in claim 1, wherein said electrically conductive layer is a two-layered copper layer having a total thickness of 20 μm or less and composed of a copper layer formed by a sputtering method and an electrolytic copper layer formed by an electrolytic plating using said copper layer as an electrode.

8. A flexible circuit board comprising a film laminate according to claim 1 with said electrically conductive layer being patterned to form a circuit, and a copper plating layer provided on said circuit.

9. A flexible circuit board obtainable by a method comprising forming a photosensitive resin over said electrically conductive layer of a film laminate according to claim 1, patterning said photosensitive layer to expose said electrically conductive layer, copper-plating said exposed electrically conductive layer to form a copper layer, and removing remaining photosensitive resin and said electrically conductive layer below said remaining photosensitive resin.
